(19) United States
(12) Patent Application Publication
(10) Pub. No.: US 2015/0253895 A1
(43) Pub. Date: Sep. 10, 2015

(54) TOUCH SENSOR

(71) Applicant: Hak Soo KIM, Cheongju-si (KR)

(72) Inventor: Hak Soo KIM, Cheongju-si (KR)

(73) Assignee: DONGBU HITEK CO., LTD., Bucheon-si (KR)

(21) Appl. No.: 14/275,703

(22) Filed: May 12, 2014

(30) Foreign Application Priority Data
Mar. 5, 2014 (KR) 10-2014-0025865

(51) Int. Cl. G06F 3/044

(52) U.S. Cl. CPC G06F 3/044

(57) ABSTRACT

A touch panel is disclosed. The touch panel includes driving lines and sensing lines. A node capacitor is formed between a driving line and an adjacent sensing line. The touch panel also includes a driver configured to demodulate a driving signal using a direct sequence spread spectrum method and supply the demodulated driving signal to each of the driving lines, and a sensor electrically connected to the sensing lines, configured to detect a variation in a capacitance of the node capacitors. The sensor demodulates a signal from the sensing line using the direct sequence spread spectrum method.

This application claims the benefit of Korean Patent Application No. 10-2014-0025865, filed on Mar. 5, 2014, which is hereby incorporated by reference as if fully set forth herein.

### BACKGROUND OF THE INVENTION

1. Field of the Invention

The present invention relates to a touch sensor.

2. Discussion of the Related Art

A touch sensor input may include a driving signal input from a capacitor formed between a sensing electrode and a driving electrode of a touch panel, and a noise signal input from a capacitor formed between a sensing node of the touch panel and an object (e.g., a finger) touching the touch panel. A sensed signal may be the signal obtained by mixing the two signals.

A sensor element of the touch sensor detects variations in mutual capacitance, and a digital processor of the touch sensor processes the detected variations in mutual capacitance. In response to the processed information being transferred to firmware, the firmware performs one or more calculations, extracts x and y coordinates, and transfers final touch location information to a host. Resolution of information transferred from the digital processor may be a factor for the accuracy in terms of coordinate calculation by the firmware.

In the case of serious radiation noise, for example due to a fluorescent light around the touch sensor, or other serious noise, for example due to a charger near, on or in communication with the touch sensor, an amplified output (e.g., from an operating amplifier) of an analog signal sensor of the touch sensor may be outside a normal operating range, and/or an output waveform of the analog signal sensor may be distorted due to overlap with the noise, and it may be impossible to normally transfer touch information.

### SUMMARY OF THE INVENTION

Accordingly, the present invention is directed to a touch sensor that substantially obviates one or more problems due to limitations and disadvantages of the related art.

An object of the present invention is to provide a touch sensor that enhances noise immunity.

Additional advantages, objects, and features of the invention will be set forth in part in the description which follows and in part will become apparent to those having skill in the art upon examination of the following or may be learned from practice of the invention. The objectives and other advantages of the invention may be realized and attained by the structures particularly pointed out in the written description and claims hereof as well as the appended drawings.

To achieve these objects and other advantages and in accordance with the purposes of the invention, as embodied and broadly described herein, a touch sensor includes a touch panel including a plurality of driving lines and a plurality of sensing lines, wherein a node capacitor is formed between each of the driving lines and an adjacent sensing line. The touch sensor further includes a driver configured to demodulate a driving signal using a direct sequence spread spectrum method and supply the demodulated driving signal to each of the driving lines, and a sensor electrically connected to the sensing lines, configured to detect a variation in a capacitance of the node capacitor, wherein the sensor demodulates a signal from the sensing line using the direct sequence spread spectrum method.

The driver may include a driving circuit connected to each of the driving lines, and the driving circuit may multiply the driving signal by a first pseudo-random binary sequence to output (or generate) the demodulated driving signal (e.g., according to a multiplication result).

The sensor may multiply the signal from the sensing line by a second pseudo-random binary sequence to output (or generate) a demodulated signal (e.g., according to a second multiplication result), and the second pseudo-random binary sequence may be equal to the first second pseudo-random binary sequence.

The sensor may include an amplifier configured to amplifying the signal from the sensing line to output (or generate) an amplified signal (e.g., according to an amplification result), and a demodulator configured to demodulate the amplified signal using the direct sequence spread spectrum method and output (or generate) a demodulated signal (e.g., according to a demodulation result).

The sensor may further include an integrator configured to integrate the demodulated signal and output (or generate) an integrated signal (e.g., according to an integration result).

The sensor may further include a first comparator configured to compare the integrated signal and a first reference voltage to output (or generate) a first comparison signal (e.g., according to a comparison result), and the first reference voltage may be a voltage of the signal from the sensing line when the touch panel is not touched.

The touch sensor may further include an analog-digital converter configured to convert the first comparison signal and output (or generate) a digital signal.

The sensor may further include a second analog-digital converter configured to convert the integrated signal to a first digital signal, and an operator configured to combine the first digital signal and a reference digital signal to output (or generate) a second digital signal (e.g., according to a combination result), and the reference digital signal may be a digital signal corresponding to an analog first reference voltage, and the first reference voltage may be a voltage of the signal from the sensing line when the touch panel is not touched or in operation.

The sensor may further include a second comparator configured to compare a voltage of the integrated signal and a second reference voltage to output (or generate) a second comparison signal (e.g., according to a second comparison result), and a counter configured to count the second comparison signal to output (or generate) a digital count signal (e.g., according to a counting result).

The amplifier may include an operating amplifier including a first input terminal connected to the sensing line, a second input terminal connected to a ground source, and an output terminal configured to output the amplified signal. The amplifier may additionally or alternatively include a feedback capacitor connected between the output terminal and the first input terminal of the operating amplifier.

In another aspect of the present invention, a touch sensor includes a touch panel including driving lines and sensing lines, where a node capacitor is formed between each driving line and an adjacent sensing line. The touch sensor further includes a driver configured to multiply a driving signal by a first pseudo-random binary sequence and supply (or generate) a demodulated driving signal (e.g., according to a first multiplication result) to each of the driving lines, and a sensor electrically connected to the sensing lines, configured to detect a variation in a capacitance of the node capacitors. The sensor is configured to amplify a signal from the sensing line and output (or generate) an amplified signal (e.g., according to an amplification result), multiply the amplified signal by a second pseudo-random binary sequence to generate (or output) a demodulated signal (e.g., according to a second multiplication result, and integrate the demodulated signal to output (or generate) an integrated signal (e.g., according to an integration result). The second pseudo-random binary sequence may be equal to the first pseudo-random binary sequence.

The sensor may compare the demodulated signal and a first reference voltage to output (or generate) a first comparison signal (e.g., according to a first comparison result), and the first reference voltage may be a voltage of the signal from the sensing line when the touch panel is not touched.

The sensor may convert the first comparison signal to a digital signal.

The sensor may convert the integrated signal to a first digital signal, and combine the first digital signal and a reference digital signal to output (or generate) a second digital signal (e.g., according to a combination result), and the reference digital signal may be a digital signal corresponding to an analog first reference voltage, and the first reference voltage may be a voltage of the signal from the sensing line when the touch panel is not touched or in operation.

The sensor may compare a voltage of the integrated signal and a second reference voltage to output (or generate) a second comparison signal (e.g., according to a second comparison result), and count the second comparison signal to output (or generate) a digital signal (e.g., according to a counting result).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an exemplary touch sensor according to one or more embodiments of the present invention;

FIG. 2 is a block diagram illustrating an exemplary driver suitable for the touch sensor in FIG. 1 according to one or more embodiments of the present invention;

FIG. 3 is a block diagram illustrating an exemplary sensor suitable for the touch sensor in FIG. 1 according to one or more embodiments of the present invention;

FIG. 4 is a diagram illustrating an exemplary first driving circuit suitable for the touch sensor in FIG. 1 according to one or more embodiments of the present invention;

FIG. 5 illustrates one or more embodiments of an exemplary first sensing circuit suitable for the sensor in FIG. 3;

FIG. 6 illustrates another embodiment of the exemplary first sensing circuit suitable for the sensor in FIG. 3;

FIG. 7 illustrates an exemplary reference digital signal generator according to one or more other embodiments of the present invention;

FIG. 8 illustrates another embodiment of the exemplary first sensing circuit suitable for the sensor in FIG. 3;

FIG. 9 illustrates another embodiment of the exemplary first sensing circuit suitable for the sensor in FIG. 3;

FIG. 10 illustrates an exemplary power spectrum in a frequency domain of an exemplary modulated driving signal;

FIG. 11 illustrates an exemplary power spectrum in a frequency domain of an exemplary demodulated signal; and

FIG. 12 illustrates an exemplary power spectrum in a frequency domain of an exemplary integrated signal.

### DETAILED DESCRIPTION OF THE INVENTION

Reference will now be made in detail to embodiments of the present invention, examples of which are illustrated in the accompanying drawings. In the description of various elements, it will be understood that when an element or layer is referred to as being “on” or “under” another element or layer, the element or layer can be directly on another element or layer or intervening elements or layers, and criteria for “on” and “under” can be provided based on the drawings.

Elements in the drawings may be exaggerated, omitted, or schematically illustrated for conveniences and clarity of explanation, and the sizes of elements do not necessarily reflect their actual sizes. In addition, the same reference numerals in the drawings denote the same or similar elements.

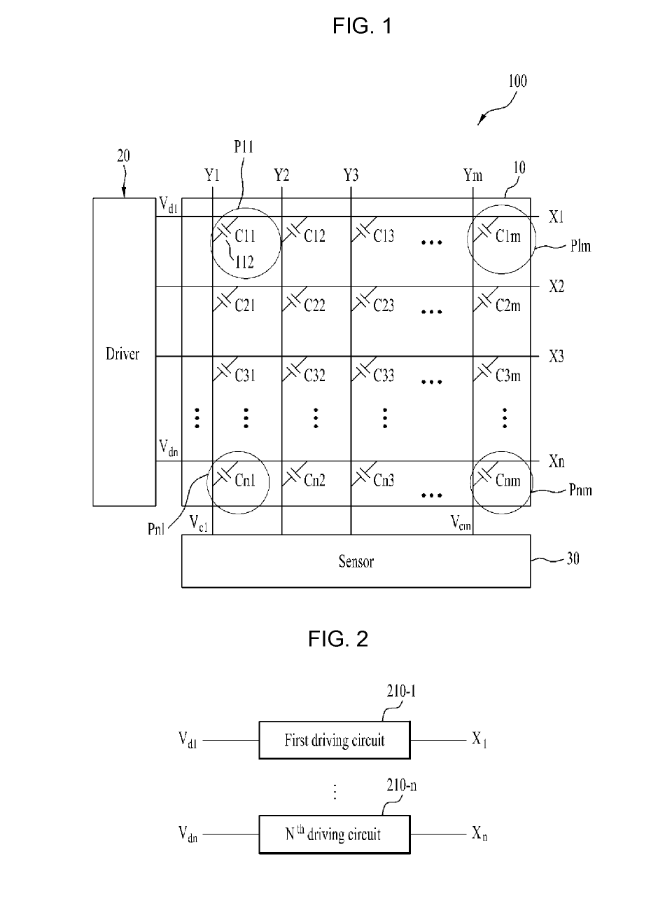

FIG. 1 is a block diagram of a touch sensor 100 according to one or more embodiments of the present invention.

Referring to FIG. 1, the touch sensor 100 includes a touch panel 10, a driver 20, and a sensor 30.

The touch panel 10 may perform a substantially independent function, and includes a plurality of sensing nodes P11 to Pnm (in which n and m are each a natural number greater than 1) present at different locations.

The sensing nodes P11 to Pnm (in which n and m are each a natural number greater than 1) may be interchangeable with coordinates, sensing points, nodes, a sensing node array, or the like.

For example, the touch panel 10 may include a plurality of driving lines X1 to Xn (in which n is a natural number greater than 1), a plurality of sensing lines Y1 to Ym (in which m is a natural number greater than 1), and a plurality of node capacitors C11 to Cnm (in which n and m are each a natural number greater than 1) formed between a driving line and a sensing line and which are adjacent to two or more other node capacitors.

The driving lines X1 to Xn (in which n is a natural number greater than 1) may be interchangeable with driving signal lines, driving electrodes, or the like.

In addition, the sensing lines Y1 to Ym (in which m is a natural number greater than 1) may be interchangeable with sensing signal lines, sensing electrodes, or the like.

In FIG. 1, driving lines and sensing lines cross each other. However, embodiments of the present invention are not limited thereto. That is, the driving lines and the sensing lines may be embodied as not crossing each other.

Any one sensing node (e.g., P11) may be defined by any one node capacitor (e.g., C11) formed between any one driving line (e.g., X1) and any one sensing line (e.g., Y1) adjacent thereto or crossing thereover or thereunder.

For example, a driving line Xi (i is a natural number satisfying 0<i≦n) and a sensing line Yj (j is a natural number satisfying 0<j≦m) may be insulated and/or separated from each other. A node capacitor Cij may be formed between the driving line Xi (i is a natural number satisfying 0<I≦n) and the sensing line Yj (j is a natural number satisfying 0<j≦m).

For example, the touch panel 10 may include an electrode pattern layer (not shown) including a sensing electrode and a driving electrode that are spaced apart from each other, a substrate (not shown) in front of, above or below the electrode pattern layer, and an insulating layer (not shown) behind (e.g., above or below) the electrode pattern layer. In one specific example, the substrate is above the electrode pattern layer(s), and the insulating layer is below the electrode pattern layer(s). A layout of the electrode pattern layer(s) may have various shapes according to the design and/or design method.

The electrode pattern layer may comprise or be formed of at least one transmissive or transparent conductive material, for example, indium tin oxide (ITO), tin oxide (TO), indium zinc oxide (IZO), indium tin zinc oxide (ITZO), indium aluminum zinc oxide (IAZO), indium gallium zinc oxide (IGZO), indium gallium tin oxide (IGTO), aluminum zinc oxide (AZO), antimony tin oxide (ATO), gallium zinc oxide (GZO), carbon nanotubes (CNT), a conductive polymer, or a silver (Ag) or copper (Cu) transparent ink.

The electrode pattern layer may be formed on one or more layers comprising, consisting, or formed of glass or plastic by a coating process (e.g., spin-coating, sputtering, chemical vapor deposition, or evaporation) and patterning (e.g., photolithography and etching) to form a sensing node array P11 to Pnm (in which n and m are each a natural number greater than 1).

The substrate may comprise or be in the form of a dielectric film with high light transmittance, and may include at least one of, for example, glass, polyethylene terephthalate (PET), polyethylene naphthalate (PEN), polyimide (PI), and acrylate/methacrylate polymers.

The insulating layer may comprise or be a transmissive insulating layer such as a PET layer, or the like. According to one or more other embodiments of the present invention, a shielding layer (not shown) may be below the insulating layer and may block or remove electromagnetic interference (EMI) and/or noise from the electrode pattern layer.

The touch panel 10 may be merged or combined with a layer for display, and the touch panel 10 and the merged or combined layer may share a driving or sensing path, according to an appropriate panel design method. The touch panel that is not merged with the display may include a 2D sensing node array using an appropriate method. Embodiments of the present invention may be applied to any touch sensing system, including a 2D sensing node array.

The driver 20 may be electrically connected to the plural driving lines X1 to Xn (in which n is a natural number greater than 1) and may supply driving signals Vd1 to Vdn (in which n is a natural number greater than 1) to the driving lines X1 to Xn (in which n is a natural number greater than 1).

The driver 20 may supply a driving signal to at least one of the plural driving lines X1 to Xn (in which n is a natural number greater than 1).

For example, the driver 20 may sequentially supply driving signals to the plural driving lines X1 to Xn (in which n is a natural number greater than 1), or may simultaneously supply driving signals to two or more driving lines.

Here, the term “simultaneously” may refer to precisely simultaneous cases as well as almost simultaneous cases. For example, the simultaneous cases may refer to cases that begin and end almost simultaneously and/or cases in which time periods at least partially overlap each other.

The driver 20 may include driving circuits that supply driving signals Vd1 to Vdn (in which n is a natural number greater than 1) to the plural driving lines X1 to Xn (in which n is a natural number greater than 1).

FIG. 2 is a block diagram illustrating an exemplary driver 20 suitable for use in FIG. 1 according to one or more embodiments of the present invention.

Referring to FIG. 2, the driver 20 may include first to n^{th} driving circuits 210-1 to 210-n (in which n is a natural number greater than 1).

The first to nth driving circuits 210-1 to 210-n (in which n is a natural number greater than 1) may supply driving signals Vd1 to Vdn (in which n is a natural number greater than 1) to the driving lines X1 to Xn (in which n is a natural number greater than 1).

For example, each of the first to nth driving circuits 210-1 to 210-n (in which n is a natural number greater than 1) may supply a corresponding one of the driving signals Vd1 to Vdn (in which n is a natural number greater than 1) to a corresponding one of the plural driving lines X1 to Xn (in which n is a natural number greater than 1).

The sensor 30 may be electrically connected to the plural sensing lines Y1 to Ym (in which m is a natural number greater than 1), and may detect the capacitance of a node capacitor between a driving line with a driving signal supplied thereto and a sensing line corresponding to (or crossing) the driving line.

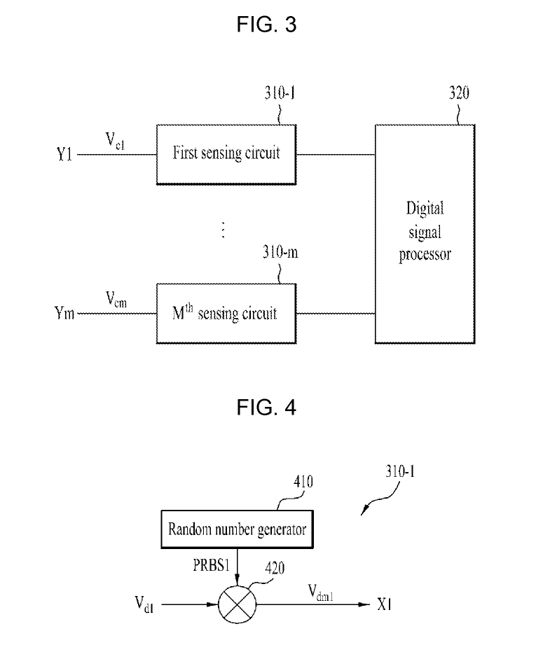

FIG. 3 is a block diagram illustrating an exemplary sensor 30 suitable for use in FIG. 1 according to one or more embodiments of the present invention.

Referring to FIG. 3, the sensor 30 includes first to m^{th} sensing circuits 310-1 to 310-m (in which m is a natural number greater than 1), and a digital signal processor 320.

Each of the first to m^{th} sensing circuits 310-1 to 310-m (in which m is a natural number greater than 1) may be connected to a corresponding one of the plural sensing lines Y1 to Ym (in which m is a natural number greater than 1) and may sense a signal from a corresponding one of sensing lines.

The digital signal processor 320 detects capacitor variations of the sensing nodes P11 to Pnm (in which n and m are each a natural number greater than 1) as the sensing result obtained from the first to m^{th} sensing circuits 310-1 to 310-m (in which m is a natural number greater than 1).

The digital signal processor 320 may process the digital signals (e.g., DS1) output from the first to mth sensing circuits 310-1 to 310-m (in which m is a natural number greater than 1) according to various digital signal processing schemes (e.g., filtering, amplifying, noise removal, signal detection, etc.).

FIG. 4 is a diagram illustrating an exemplary first driving circuit 210-1 suitable for use in FIG. 2 according to one or more embodiments of the present invention.

The first to n^{th} driving circuits 210-1 to 210-n (in which n is a natural number greater than 1) illustrated in FIG. 2 may have the same structure. Thus, only the structure of the first driving circuit 210-1 will be described below, and a detailed description of the remaining driving circuits will be omitted to avoid repetition.

Referring to FIG. 4, the first driving circuit 210-1 modulates the driving signal Vd1 using a spread spectrum method (e.g., a direct sequence spread spectrum method), and outputs the modulated driving signal Vdm1.

For example, the first driving circuit 210-1 may multiply a first pseudo-random binary sequence (PRBS1) by the driving signal Vd1, and output the modulated driving signal Vdm1 according to the multiplication result. In this case, a period for the first PRBS may be shorter than a period for the driving signal Vd1.

FIG. 10 illustrates an exemplary power spectrum in a frequency domain of an exemplary modulated driving signal Vdm1.

As can be seen from FIG. 10, the modulated driving signal Vdm1 is converted into a spread spectrum signal with reduced power density per unit frequency (or frequency band). Reference numeral 901 indicates a spectrum of the modulated driving signal Vdm1, and reference numeral 902 indicates a spectrum of a noise signal introduced into the signal Vc1 (see, e.g., FIG. 3) from the first sensing line Y1.

Referring to FIG. 4, the first driving circuit 210-1 may include a random number generator 410 and a modulator 420.

The random number generator 410 may generate a pseudo-random binary sequence (PRBS).

The modulator 420 may multiply a pseudo-random sequence (PRS) such as the PRBS and the driving signal Vd1, and output the modulated driving signal Vdm1 according to the multiplication result.

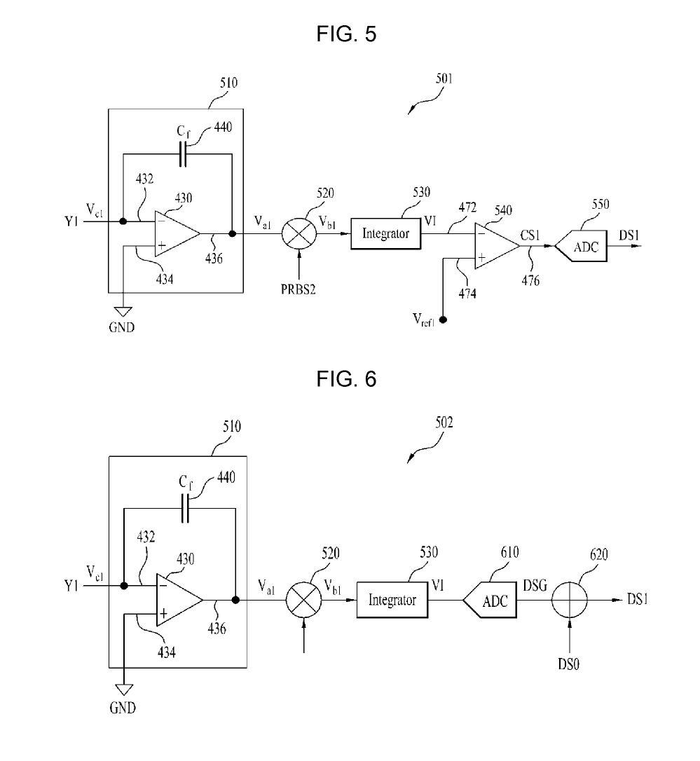

FIG. 5 illustrates an embodiment 501 of the first sensing circuit 310-1 suitable for use in the exemplary sensor of FIG. 3.

The sensing circuits 310-1 to 310-m (in which m is a natural number greater than 1) illustrated in FIG. 3 may have the same structure. Thus, only the structure of the first sensing circuit 310-1 will be described below, and a detailed description of the remaining driving circuits will be omitted to avoid repetition.

Referring to FIG. 5, the first sensing circuit 501 amplifies the signal Vc1 from the first sensing line Y1, demodulates the amplified signal Val using a direct sequence spread spectrum scheme to generate a demodulated signal Vb1, integrates on the demodulated signal Vb1 to output an integrated signal VI according to the integration result, compares the integrated signal VI and a first reference voltage Vref1 to output a comparison signal CS1 according to the comparison result, and converts the analog comparison signal CS1 to a digital signal DS1.

The first reference voltage Vref1 may be a signal corresponding to a signal received to the sensing line Y1 when the touch panel 10 is not touched or otherwise contacted.

The first sensing circuit 501 may include an amplifier 510, a demodulator 520, an integrator 530, a comparator 540, and an analog-to-digital converter 550.

The amplifier 510 amplifies the signal Vc1 from the first sensing line Y1 to output the amplified signal Val.

The amplifier 510 may include a first amplifier 430 and a feedback capacitor 440.

The first amplifier 430 may include a first input terminal 432 (e.g., an inverting terminal) connected to a corresponding sensing line (e.g., Y1), a second input terminal 434 (e.g., a non-inverting terminal) connected to a ground source or potential, and an output terminal 436 configured to output the amplified signal Val.

The first amplifier 430 may comprise or be a differential amplifier configured to differentially amplify the first signal Vc1 input to the first input terminal 432 (e.g., relative to a second signal GND input to the second input terminal 434), or a difference between the first signal Vc1 and the ground potential. In FIG. 5, the first amplifier 430 is exemplified as an operating amplifier, which may be embodied as a field effect transistor (FET) or a bipolar junction transistor (BJT), but is not limited thereto.

The feedback capacitor 440 may be electrically connected between the output terminal 436 and the first input terminal 432 of the first amplifier 430.

The feedback capacitor 440 may provide negative feedback from the output signal Val of the first amplifier 430 to the first input terminal 432.

Although not illustrated in FIG. 5, according to another embodiment of the present invention, the amplifier 510 may further include a feedback resistor (not shown) that is electrically connected between the output terminal 436 and the first input terminal 432 of the first amplifier 430. For example, the feedback resistor and the feedback capacitor 440 may be connected in parallel to each other between the output terminal 436 and the first input terminal 432 of the first amplifier 430.

The demodulator 520 demodulates the amplified signal Val via a direct sequence spread spectrum scheme to generate the demodulated signal Vb1 according to the demodulation.

For example, the demodulator 520 may multiply the amplified signal Val by a second pseudo-random binary sequence (PRBS2) to output the demodulated signal Vb1 according to the multiplication result.

The second pseudo-random binary sequence (PRBS2) may be the same as the first pseudo-random binary sequence (PRBS1). For example, the second pseudo-random binary sequence (PRBS2) may have the same size, period, and synchronization as the first pseudo-random binary sequence (PRBS1).

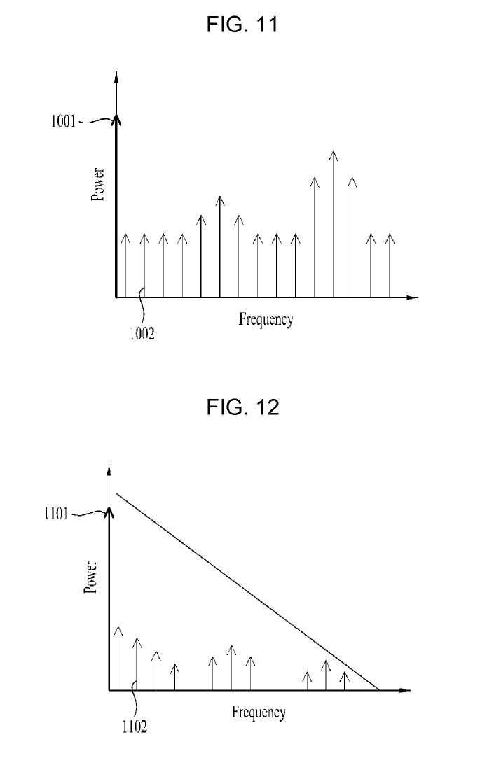

FIG. 11 illustrates a power spectrum in a frequency domain of the demodulated signal Vb1.

As can be seen from FIG. 11, a spectrum portion 1001 corresponding to the driving signal Vd1 of the demodulated signal Vb1 is present in a low frequency band (e.g., a domain with frequency of 0), and a spectrum portion 1002 corresponding to environment noise is dispersed or spread over a wider frequency domain (e.g., a user or user-defined frequency domain).

The integrator 530 integrates the demodulated signal Vb1 to output the integrated signal VI according to the integration result.

In response to the demodulated signal Vb1 being integrated by the integrator 530, a spectrum portion corresponding to the driving signal Vd1 present in a low frequency band may be added, and a spectrum portion corresponding to noise present in a relatively high frequency band may be removed. That is, the integrator 530 may function as a low pass filter.

FIG. 12 illustrates a power spectrum in a frequency domain of the integrated signal VI.

Referring to FIG. 12, only a high frequency band portion of the demodulated signal Vb1 may be removed by the integrator 530 to remove noise due to the surrounding environment of the touch sensor 100. That is, it may be seen that a spectrum portion 1101 corresponding to a driving signal Vd of the integrated signal VI is maintained, a noise portion in a high frequency band is removed, and only a noise portion 1102 in a low frequency band remains.

The comparator 540 compares the integrated signal VI and the first reference voltage Vref1 to output the comparison signal CS1 according to the comparison result.

The comparator 540 may detect a variation or difference Vc1-Vref1 between the voltage Vref1 from the sensing line Yj when the touch pad 10 is not touched and the voltage Vc1 from the sensing line Yj based on variation of the mutual capacitance Cm when the touch pad 10 is touched or in use. The voltage variation Vc1-Vref1 may be about −20% of the first reference voltage Vref1.

For example, the comparator 540 may include a first input terminal (e.g., an inverting terminal) to which the integrated signal VI is input, a second input terminal (e.g., a non-inverting terminal) to which the first reference voltage Vref1 is input, and an output terminal from which the comparison signal CS1 is output.

Voltage variation Vref1-VI is used as touch information by the comparator 540, and thus, the input dynamic range of the analog-digital converter 550 may be reduced.

According to another embodiment of the present invention, the integrator 530 and the comparator 540 may be integrated with each other so as to simultaneously perform a comparison operation with the first reference voltage Vref1 whenever the signal Vb1 is integrated.

According to another embodiment of the present invention, locations of the integrator 530 and the comparator 540 may be exchanged, and a comparison operation of the comparator 540 may be performed and then an integration operation of the integrator 530 may be performed.

The analog-digital converter 550 converts the analog comparison signal CS1 output by the comparator 540 to the digital signal DS1.

The driving signal is modulated using a pseudo-random binary sequence (PRBS) to reduce, minimize or avoid any correlation with noise caused by the surrounding environment of the touch sensor 100. Thus, one or more embodiments of the present invention can enhance noise immunity without a complex noise avoidance algorithm, and can more accurately extract a variation or difference in the mutual capacitance Cm of driving and sensing lines in the touch screen or touch panel.

When a typical noise avoidance algorithm is used, a digital signal processor may consume a predetermined period of time in order to search for a frequency band with low noise for response time taken to feedback a result of a touch event of the touch panel.

On the other hand, according to one or more embodiments of the present invention, since the driving signal may be spread over an entire frequency band by the modulator 420, it is not necessary to search for a frequency band with low noise, and thus, response time of the digital signal processor 320 can be enhanced, and integrated operation time required for noise filtering can be ensured, thereby enhancing noise removing performance.

According to one or more embodiments of the present invention, only the voltage variation Vref1-VI is used for touch information by the comparator 540, and thus, the input dynamic range of the analog-digital converter 550 can be reduced, and a low power analog-digital converter can be used.

FIG. 6 illustrates another embodiment 502 of the first sensing circuit 310-1 suitable for use in the exemplary sensor of FIG. 3. The same reference numerals in FIGS. 5 and 6 denote the same elements, and a detailed description of the same elements may be omitted and only schematically given.

Referring to FIG. 6, the first sensing circuit 502 amplifies the signal Vc1 from the first sensing line Y1, demodulates the amplified signal Val using a direct sequence spread spectrum method to generate the demodulated signal Vb1, integrates the demodulated signal Vb1 to output the integrated signal VI according to the integration result, converts the (analog) integrated signal VI to a converted (e.g., digital) signal DSG, and combines a reference digital signal DS0 and the converted signal DSG to output the digital signal DS1.

In this case, the reference digital signal DS0 may be a signal obtained by converting the analog first reference voltage Vref1 to a digital signal (e.g., voltage).

The first sensing circuit 502 may include the amplifier 510, the demodulator 520, the integrator 530, an analog-digital converter 610, and an operator 620.

The analog-digital converter 610 may convert the analog integrated signal VI to a converted (e.g., digital) signal DSG.

The operator 620 may combine the converted signal DSG and the reference digital signal DS0 to output the digital signal DS1 (e.g., a combined digital signal) according to the combination result.

The first sensing circuit 502 may further include a reference digital signal generator configured to generate the reference digital signal DS0. For example, the reference digital signal generator may comprise an analog-to-digital converter configured to convert the analog first reference voltage to a corresponding digital signal representing the first reference voltage as a digital value.

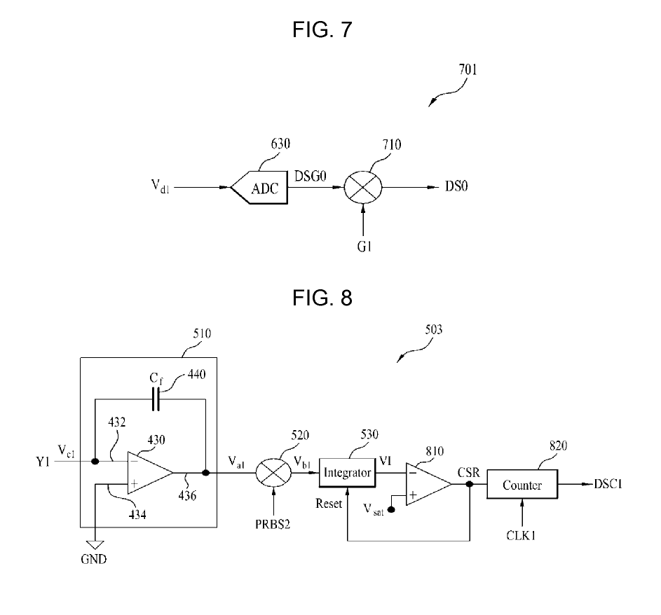

FIG. 7 illustrates a reference digital signal generator 701 according to an embodiment of the present invention.

Referring to FIG. 7, the reference digital signal generator 701 may include an analog-digital converter 630 configured to convert the analog driving signal Vd1 supplied from a driving line (e.g., X1) to a converted (e.g., digital) signal DSG0, and an operator 710 configured to multiply the converted signal DSG0 by a reference gain G1 to output the reference digital signal DS0.

The reference gain G1 may be a gain when the touch pad 10 is not touched or in operation.

For example, the reference gain G1 may be Call/Cf, and Call may be the capacitance of a node capacitor C11 when the touch pad 10 is not touched or in operation.

The embodiment 501 of FIG. 5 may convert the variation in or difference between the integrated signal VI and the first reference voltage Vref1 (e.g., an analog signal) to the digital signal DS1. On the other hand, the embodiment 502 of FIG. 6 may convert each of the integrated signal VI and the first reference voltage Vref1 to corresponding digital signals, and then combine the results DSG and DS0 to generate the digital signal DS1.

FIG. 8 illustrates another embodiment 503 of the first sensing circuit 310-1 suitable for use in the exemplary sensor of FIG. 3. The same reference numerals in FIGS. 5 and 8 denote the same elements, and a detailed description of the same elements may be omitted and only schematically given.

Referring to FIG. 8, the first sensing circuit 503 may include the amplifier 510, the demodulator 520, the integrator 530, a comparator 810, and a counter 820.

The comparator 810 compares a voltage of the integrated signal VI and a second reference voltage Vsat to output a comparison signal CSR according to the comparison result.

When a voltage of the integrated signal VI becomes the second reference voltage Vsat, an output value of the comparison signal CSR may be transitioned. The integrated signal VI is a value obtained by integrating the demodulated signal Vb1, and thus, the voltage of the integrated signal VI may increase over time.

The second reference voltage Vsat may be a saturation value, that is, a maximum value of an operating voltage of the sensing circuit 310-1.

The counter 820 counts the comparison time of the comparator 810 to generate a digital value DSC1 according to the counting result in response to the comparison signal CSR.

Here, the comparison time may be a time until the voltage of the integrated signal VI becomes equal to a second reference voltage Vsat (e.g., beginning from an initial time immediately prior to the touch event, when the voltage of the integrated signal VI corresponds to an untouched touch screen or panel). That is, inclination of the integrated signal VI over time may change based on a variation in capacitance of the node capacitor C11 due to a touch event, and the comparison time may be determined according to the inclination of the integrated signal VI.

For example, the integrator 530 may output the comparison signal CSR having a first level (e.g., a high level) whenever the integrated signal VI becomes greater than the second reference voltage Vsat. In addition, the first level of the comparison signal CSR may be maintained until the integrated signal VI becomes lower than the second reference voltage Vsat after the integrated signal VI is reset to an initial value.

When the integrated signal VI becomes equal to the second reference voltage Vsat, the integrator 530 may be reset. This is because the integrated signal VI prevents an operating voltage of a sensing circuit (e.g., 310-1) from exceeding an operating voltage range to prevent a faulty operation of sensing circuit (e.g., 310-1).

For example, when the comparison signal CSR becomes or equals a first level, the comparison signal CSR may function as a reset signal Reset configured to reset the integrator 530, and may reset the integrator 530. When the integrator 530 is reset, the integrated signal VI may be reset to an initial value.

The counter 820 may measure a period for the comparison signal CSR (e.g., the change in value of the comparison signal CSR) using a clock signal CLK, and generate the digital value DSC1 based on the measured period. In addition, the counter 820 may count the number of first levels generated in the comparison signal CSR using the clock signal CLK, and generate the digital value DSC1 based on the counting result.

The embodiment 503 of FIG. 8 may be an example in which the analog-digital converter 610 suitable for use in FIG. 6 is embodied using the comparator 810 and the counter 820, but is not limited thereto. That is, according to various embodiments of the present invention, an analog-digital converter may be embodied.

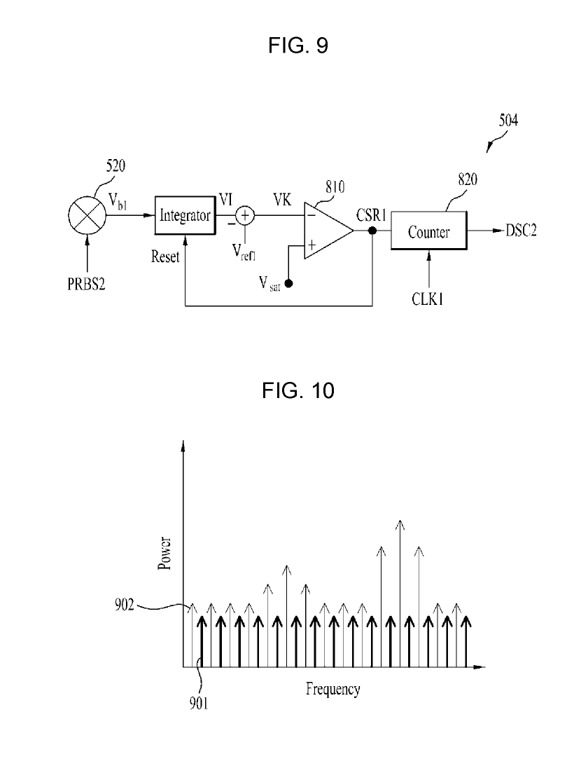

FIG. 9 illustrates another embodiment 504 of the first sensing circuit 310-1 suitable for use in the exemplary sensor of FIG. 3. The same reference numerals in FIGS. 8 and 9 denote the same elements, and a detailed description of the same elements may be omitted and only schematically given.

Referring to FIG. 9, the embodiment 504 may further include a subtractor 560 in addition to some of the components in the embodiment 503 of FIG. 8.

The subtractor 560 may subtract the first reference voltage Vref1 from the integrated signal VI to output a difference signal VK according to the subtraction result. The integrated signal VI is a value obtained by integrating the demodulated signal Vb1, and thus, the difference signal VK may increase over time.

The comparator 810 may compare the difference signal VK and the second reference voltage Vsat to output a comparison signal CSR1 according to the comparison result.

The counter 820 may measure a period for the comparison signal CSR1 using the clock signal CLK to generate the digital value DSC1 based on the measured period. In addition, the counter 820 may count the number of first levels generated in the comparison signal CSR1 using the clock signal CLK to generate a digital value DSC2 based on the counting result.

According to the embodiments of the present invention, noise immunity can be enhanced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A touch sensor comprising:
a touch panel comprising a plurality of driving lines and a plurality of sensing lines, wherein a node capacitor is formed between each of the driving lines and an adjacent one of the sensing lines;
a driver configured to demodulate a driving signal using a direct sequence spread spectrum method and supply the demodulated driving signal to each of the driving lines; and
a sensor electrically connected to the sensing lines, configured to detect a variation in a capacitance of the node capacitors,
wherein the sensor demodulates a signal from the sensing line using the direct sequence spread spectrum method.

2. The touch sensor according to claim 1, wherein:
the driver comprises a driving circuit connected to each of the driving lines;
the driving circuit is configured to multiply the driving signal by a first pseudo-random binary sequence, and output the demodulated driving signal.

3. The touch sensor according to claim 2, wherein the sensor is configured to multiply the signal from the sensing line by a second pseudo-random binary sequence and output a demodulated signal.

4. The touch sensor according to claim 3, wherein the second pseudo-random binary sequence is equal to the first second pseudo-random binary sequence.

5. The touch sensor according to claim 1, wherein the sensor comprises:
an amplifier configured to amplify the signal from the sensing line and output an amplified signal; and
a demodulator configured to demodulating the amplified signal using the direct sequence spread spectrum method to output a demodulated signal.

6. The touch sensor according to claim 5, wherein the sensor further comprises an integrator configured to integrate the demodulated signal and output an integrated signal.

7. The touch sensor according to claim 6, wherein the sensor further comprises a first comparator configured to compare the integrated signal and a first reference voltage and output a first comparison signal according to a first comparison result.

8. The touch sensor according to claim 7, wherein the first reference voltage is a voltage of the signal from the sensing line when the touch panel is not touched.

9. The touch sensor according to claim 7, further comprising an analog-digital converter configured to convert the first comparison signal to a first digital signal.

10. The touch sensor according to claim 6, wherein the sensor further comprises an analog-digital converter configured to convert the integrated signal to a first digital signal, and an operator configured to combine the first digital signal and a reference digital signal and output a second digital signal.

11. The touch sensor according to claim 10, wherein the reference digital signal is a digital signal corresponding to an analog first reference voltage, and the first reference voltage is a voltage of the signal from the sensing line when the touch panel is not touched or in operation.

12. The touch sensor according to claim 7, wherein the sensor further comprises a second comparator configured to compare a voltage of the integrated signal and a second reference voltage, and output a second comparison signal.

13. The touch sensor according to claim 12, wherein the sensor further comprises a counter configured to count the second comparison signal and output a digital count signal.

14. The touch sensor according to claim 5, wherein the amplifier comprises:
an operating amplifier comprising a first input terminal connected to the sensing line, a second input terminal connected to a ground source, and an output terminal configured to output the amplified signal; and
a feedback capacitor connected between the output terminal and the first input terminal of the operating amplifier.

15. A touch sensor comprising:
a touch panel comprising a plurality of driving lines and a plurality of sensing lines, wherein a node capacitor is formed between each of the driving lines and an adjacent sensing line;
a driver configured to multiply a driving signal by a first pseudo-random binary sequence and supply a demodulated driving signal to each of the driving lines; and
a sensor electrically connected to the sensing lines, configured to detect a variation in capacitance of the node capacitors,
wherein:
the sensor is configured to amplify a signal from the sensing lines to generate an amplified signal, multiply the amplified signal by a second pseudo-random binary sequence to generate a demodulated signal, and integrate the demodulated signal to output an integrated signal; and
the second pseudo-random binary sequence is equal to the first pseudo-random binary sequence.

16. The touch sensor according to claim 15, wherein:
the sensor is configured to compare the demodulated signal and a first reference voltage to output a first comparison signal; and
the first reference voltage is a voltage of the signal from the sensing line when the touch panel is not touched.

17. The touch sensor according to claim 16, wherein the sensor is configured to convert the first comparison signal to a digital signal.

18. The touch sensor according to claim 15, wherein the sensor is configured to convert the integrated signal to a first digital signal, and combine the first digital signal and a reference digital signal to generate a second digital signal.

19. The touch sensor according to claim 18, wherein the reference digital signal is a digital signal corresponding to an analog first reference voltage, and the first reference voltage is a voltage of the signal from the sensing line when the touch panel is not touched or in operation.

20. The touch sensor according to claim 15, wherein the sensor is configured to compare a voltage of the integrated signal and a second reference voltage to generate a second comparison signal, count the second comparison signal, and output a digital count signal.
